(19) United States
(12) Patent Application Publication
(10) Pub. No.: US 2026/0097269 A1
(43) Pub. Date: Apr. 9, 2026

(54) GOLF BALL

(71) Applicant: Sumitomo Rubber Industries, Ltd., Kobe-shi (JP)

(72) Inventors: Daijiro KOJIMA, Kobe-shi (JP); Takahiro SAJIMA, Kobe-shi (JP)

(73) Assignee: Sumitomo Rubber Industries, Ltd., Kobe-shi (JP)

(21) Appl. No.: 19/330,988

(22) Filed: Sep. 17, 2025

(30) Foreign Application Priority Data
Oct. 4, 2024 (JP) 2024-174699

(51) Int. Cl. A63B 37/00; C08F 20/00

(52) U.S. Cl. CPC A63B 37/0075; A63B 37/0036; A63B 37/0037; A63B 37/0048; A63B 37/0049; A63B 37/0063; A63B 37/0065; A63B 37/0076; A63B 37/008; A63B 37/0083; C08F 20/00

(57) ABSTRACT

A golf ball includes a core, a mid layer, and a cover. A slope A1 of a straight line connecting a central point of the core and a point at 2.5 mm from the central point and a slope A2 of a straight line connecting the point at 2.5 mm and a point at 5.0 mm from the central point are each 1.00 or more. A slope A5 of a straight line connecting a point at 10.0 mm from the central point and a point at 12.5 mm from the central point and a slope A6 of a straight line connecting the point at 12.5 mm and a point at 15.0 mm from the central point are each 1.50 or more. The cover is formed of a resin composition containing an ionomer resin, with the ionomer resin present in an amount of 60% by mass or more.

### CROSS-REFERENCE TO RELATED APPLICATION

The present application claims priority to Japanese patent application JP 2024-174699, filed on Oct. 4, 2024, the entire contents of which is incorporated herein by reference in its entirety.

### BACKGROUND

### Technical Field

The present specification discloses a golf ball including a core, a mid layer, and a cover.

### Background Art

A general golf ball includes a core, a mid layer, and a cover. Japanese Laid-Open Patent Publication No. 2023-160402 discloses a golf ball including a cover in which an ionomer resin is a principal component. The ionomer resin can contribute to the resilience performance of the cover.

An interest to golf players concerning golf balls is flight performance. Golf players place importance mainly on a flight distance upon a shot with a driver. Feel at impact of golf balls is also important for golf players. Golf players place importance on feel at impact upon putting.

Among ionomer resins, a type having a low hardness can contribute to the feel at impact of golf balls. However, covers made from this type of ionomer resin have poor scuff resistance. Furthermore, the contribution of this type of ionomer resin to resilience performance is insufficient.

Even if a cover contains an ionomer resin having a low hardness, if the thickness of the cover is sufficiently small, the cover does not significantly impair the resilience performance of a golf ball. However, molding a thin cover is difficult.

It is an intention of the applicant to provide a golf ball having excellent flight performance, feel at impact, scuff resistance, and moldability.

### SUMMARY

A golf ball disclosed in the present specification includes a core, a mid layer positioned outside the core, and a cover positioned outside the mid layer. In a graph on which distances (mm) of and Shore C hardnesses at a central point of the core, a point P1 whose distance from the central point is 2.5 mm, a point P2 whose distance from the central point is 5.0 mm, a point P4 whose distance from the central point is 10.0 mm, a point P5 whose distance from the central point is 12.5 mm, and a point P6 whose distance from the central point is 15.0 mm, are plotted,
a slope A1 of a straight line connecting the central point and the point P1 is 1.00 or more,
a slope A2 of a straight line connecting the point P1 and the point P2 is 1.00 or more,
a slope A5 of a straight line connecting the point P4 and the point P5 is 1.50 or more, and
a slope A6 of a straight line connecting the point P5 and the point P6 is 1.50 or more.

A difference (Hs-Ho) between a Shore C hardness Hs at a surface of the core and a Shore C hardness Ho at the central point is 30 or more. A material of the mid layer is a resin composition containing an ionomer resin as a principal component. A material of the cover is a resin composition containing an ionomer resin as a principal component. A ratio P(I) of an amount of the ionomer resin to a total amount of a base resin in the resin composition of the cover is 60% by mass or more. A ratio P(Na) of an amount of a sodium ion-neutralized ionomer resin to the total amount of the base resin in the resin composition of the cover is 5% by mass or less. A product (Mc*Tc) of a melt flow rate Mc (g/10 min) and a thickness Tc (mm) of the cover is 10.0 or more. The cover has a bending stiffness Fc of 75 MPa or less.

The golf ball disclosed in the present specification has excellent flight performance upon a shot with a driver, excellent feel at impact upon putting, excellent scuff resistance, and excellent moldability.

### BRIEF DESCRIPTION OF THE DRAWINGS

FIG. 1 is a partially cutaway cross-sectional view showing a golf ball according to one embodiment; and

FIG. 2 is a graph showing the hardness distribution of a core of the golf ball in FIG. 1.

### DETAILED DESCRIPTION

Hereinafter, preferred embodiments will be described in detail with appropriate reference to the drawings.

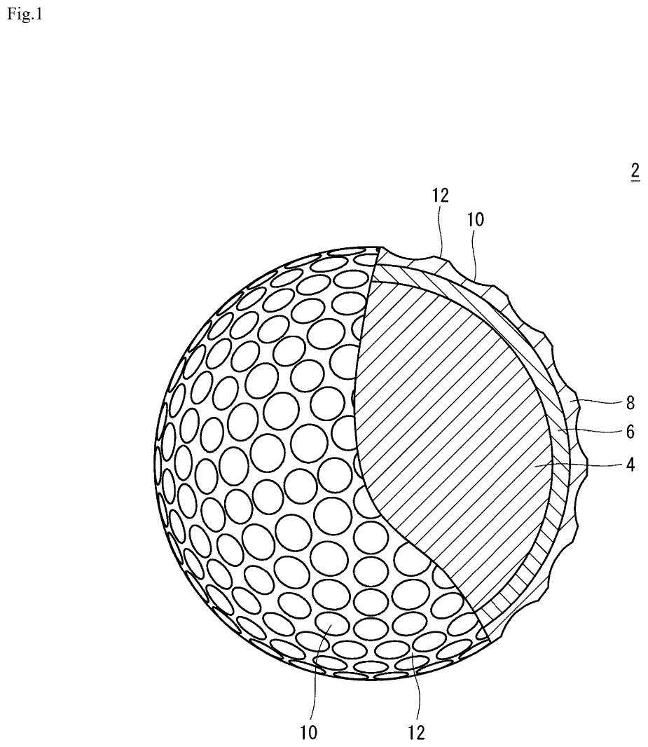

A golf ball 2 shown in FIG. 1 includes a spherical core 4, a mid layer 6 positioned outside the core 4, and a cover 8 positioned outside the mid layer 6. The golf ball 2 has a plurality of dimples 10 on the surface thereof. Of the surface of the golf ball 2, a part other than the dimples 10 is a land 12. The golf ball 2 includes a paint layer and a mark layer on the external side of the cover 8, but these layers are not shown in the drawing.

### [Core 4]

The core 4 is formed by crosslinking a rubber composition. The rubber composition contains a base rubber, a co-crosslinking agent, a crosslinking initiator, an organic sulfur compound, etc.

### [Base Rubber]

Examples of preferable base rubbers include polybutadienes, polyisoprenes, styrene-butadiene copolymers, ethylene-propylene-diene copolymers, and natural rubbers. From the viewpoint of resilience performance of the golf ball 2, polybutadienes are preferable. When a polybutadiene and another rubber are used in combination, it is preferred if the polybutadiene is a principal component. Specifically, the proportion of the polybutadiene to the entire base rubber is preferably 50% by mass or more, more preferably 70% by mass or more, and particularly preferably 80% by mass or more. A polybutadiene in which the proportion of cis-1,4 bonds is 80% or more is particularly preferable. A polybutadiene can contain 1,2-vinyl bonds. From the viewpoint of the resilience performance of the golf ball 2, the content of 1,2-vinyl bonds in the polybutadiene is preferably 2.0% by mass or less, more preferably 1.7% by mass or less, and particularly preferably 1.5% by mass or less.

### [Co-Crosslinking Agent]

Examples of preferable co-crosslinking agents include α,β-unsaturated carboxylic acids and metal salts thereof. These co-crosslinking agents can crosslink rubber molecules by graft polymerization. An α,β-unsaturated carboxylic acid and an α,β-unsaturated carboxylic acid metal salt may be used in combination. The number of carbon atoms in each of α,β-unsaturated carboxylic acids and metal salts thereof is preferably 2 or more and 8 or less. Examples of preferable α,β-unsaturated carboxylic acids include acrylic acid, methacrylic acid, fumaric acid, maleic acid, and crotonic acid.

Examples of metal ions for α,β-unsaturated carboxylic acid metal salts include: monovalent metal ions such as those of sodium, potassium, and lithium; divalent metal ions such as those of magnesium, calcium, zinc, barium, and cadmium; trivalent metal ions such as that of aluminum; tin ion; and zirconium ion. Two or more types of metal ions may be used in combination. From the viewpoint of easily crosslinking rubber molecules, divalent metal ions are preferable. Specific examples of preferable co-crosslinking agents include zinc acrylate, magnesium acrylate, zinc methacrylate, and magnesium methacrylate. Zinc acrylate is particularly preferable. Two or more co-crosslinking agents may be used in combination.

The amount of the co-crosslinking agent per 100 parts by mass of the base rubber is preferably 10 parts by mass or more and 40 parts by mass or less. With the core 4 in which the amount of the co-crosslinking agent is in this range, an appropriate hardness can be achieved. From the viewpoint of hardness, this amount is more preferably 15 parts by mass or more and particularly preferably 20 parts by mass or more. From the same viewpoint, this amount is more preferably 35 parts by mass or less and particularly preferably 30 parts by mass or less.

### [Crosslinking Initiator]

A preferable crosslinking initiator is an organic peroxide. The organic peroxide contributes to the durability and the resilience performance of the golf ball 2. Examples of suitable organic peroxides include dicumyl peroxide, 1,1-di(t-butylperoxy)cyclohexane, 1,1-bis(t-butylperoxy)-3,3,5-trimethylcyclohexane, 2,5-dimethyl-2,5-di(t-butylperoxy) hexane, and di-t-butyl peroxide. An organic peroxide with particularly high versatility is dicumyl peroxide. Two or more crosslinking initiators may be used in combination.

The amount of the crosslinking initiator per 100 parts by mass of the base rubber is preferably 0.2 parts by mass or more and 5.0 parts by mass or less. With the core 4 in which the amount of the crosslinking initiator is in this range, an appropriate hardness can be achieved. The golf ball 2 has excellent durability. From this viewpoint, this amount is more preferably 0.5 parts by mass or more and particularly preferably 0.7 parts by mass or more. From the same viewpoint, this amount is more preferably 3.0 parts by mass or less and particularly preferably 2.0 parts by mass or less.

### [Organic Sulfur Compound]

The organic sulfur compound contributes to the resilience performance of the golf ball 2. Examples of the organic sulfur compound include thiols, polysulfides, thiurams, thiocarboxylic acids, dithiocarboxylic acids, sulfenamides, dithiocarbamates, and thiazoles. Thiols include thiophenols and thionaphthols.

Preferable organic sulfur compounds are thiophenols, metal salts of thiophenols, thionaphthols, metal salts of thionaphthols, diphenyldisulfides, and thiuram disulfides. Specific examples of preferable organic sulfur compounds include 2,4-dichlorothiophenol, 2,6-difluorothiophenol, 2,6-dichlorothiophenol, 2,6-dibromothiophenol, 2,6-diiodothiophenol, 2,4,5-trichlorothiophenol, pentachlorothiophenol, 1-thionaphthol, 2-thionaphthol, diphenyldisulfide, bis(2,6-difluorophenyl)disulfide, bis(2,6-dichlorophenyl)disulfide, bis(2,6-dibromophenyl)disulfide, bis(2,6-diiodophenyl)disulfide, bis(pentabromophenyl)disulfide, and zinc salts thereof.

Two or more organic sulfur compounds may be used in combination in the rubber composition.

The amount of the organic sulfur compound per 100 parts by mass of the base rubber is preferably 0.1 parts by mass or more and 5.0 parts by mass or less. A rubber composition in which the amount of the organic sulfur compound is in this range has excellent processability. A uniform core 4 can be obtained from this rubber composition. From this viewpoint, this amount is more preferably 0.2 parts by mass or more and particularly preferably 0.3 parts by mass or more. From the same viewpoint, this amount is more preferably 3.0 parts by mass or less and particularly preferably 2.0 parts by mass or less. The golf ball 2 may include a core 4 that contains no organic sulfur compound.

### [Carboxylic Acid]

The rubber composition of the core 4 may contain a carboxylic acid or a carboxylate. The carboxylic acid and the carboxylate can contribute to making the hardness distribution of the core 4 appropriate. An example of preferable carboxylic acids is benzoic acid. Examples of preferable carboxylates include zinc octoate and zinc stearate. A particularly preferable compound is benzoic acid.

The total amount of the carboxylic acid and the carboxylate per 100 parts by mass of the base rubber is preferably 1.0 part by mass or more and 7.0 parts by mass or less. The hardness distribution of the core 4 in which this total amount is in this range is appropriate. From this viewpoint, this amount is more preferably 2.0 parts by mass or more and particularly preferably 2.5 parts by mass or more. From the same viewpoint, this amount is more preferably 5.0 parts by mass or less and particularly preferably 4.0 parts by mass or less.

### [Additives]

The rubber composition of the core 4 may contain a filler for the purpose of specific gravity adjustment and the like. Examples of suitable fillers include zinc oxide, barium sulfate, calcium carbonate, and magnesium carbonate. The amount of the filler is determined as appropriate so that the intended specific gravity of the core 4 is achieved.

The rubber composition of the core 4 may contain additives, such as a radical scavenger, sulfur, an anti-aging agent, a coloring agent, a plasticizer, and a dispersant, in an adequate amount. The rubber composition may contain crosslinked rubber powder or synthetic resin powder.

### [Diameter of Core]

The core 4 preferably has a diameter of 35.0 mm or more and 40.5 mm or less. The golf ball 2 that includes the core 4 having a diameter of 35.0 mm or more has excellent resilience performance. From this viewpoint, the diameter is more preferably 36.0 mm or more and particularly preferably 36.5 mm or more. The golf ball 2 that includes the core 4 having a diameter of 40.5 mm or less has excellent durability. From this viewpoint, the diameter is more preferably 40.0 mm or less and particularly preferably 39.5 mm or less.

### [Amount of Compressive Deformation of Core]

The core 4 preferably has an amount of compressive deformation C1 of 4.3 mm or more and 7.0 mm or less. The golf ball 2 that includes the core 4 having an amount of compressive deformation C1 of 4.3 mm or more has excellent feel at impact upon putting. From this viewpoint, the amount of compressive deformation C1 is more preferably 4.4 mm or more and particularly preferably 4.5 mm or more. The golf ball 2 that includes the core 4 having an amount of compressive deformation C1 of 7.0 mm or less has excellent flight performance upon a shot with a driver. From this viewpoint, the amount of compressive deformation C1 is more preferably 6.0 mm or less and particularly preferably 5.5 mm or less.

The amount of compressive deformation C1 is measured with a YAMADA type compression tester “SCH”. In the tester, the core 4 is placed on a rigid plate made of metal. A cylinder made of metal gradually descends toward the core 4. The core 4 squeezed between the bottom face of the cylinder and the hard plate becomes deformed. A movement distance of the cylinder, starting from the state in which an initial load of 98 N is applied to the core 4 up to the state in which a final load of 1274 N is applied thereto, is measured. A movement speed of the cylinder until the initial load is applied is 0.83 mm/s. A movement speed of the cylinder after the initial load is applied until the final load is applied is 1.67 mm/s.

### [Hardness Distribution of Core]

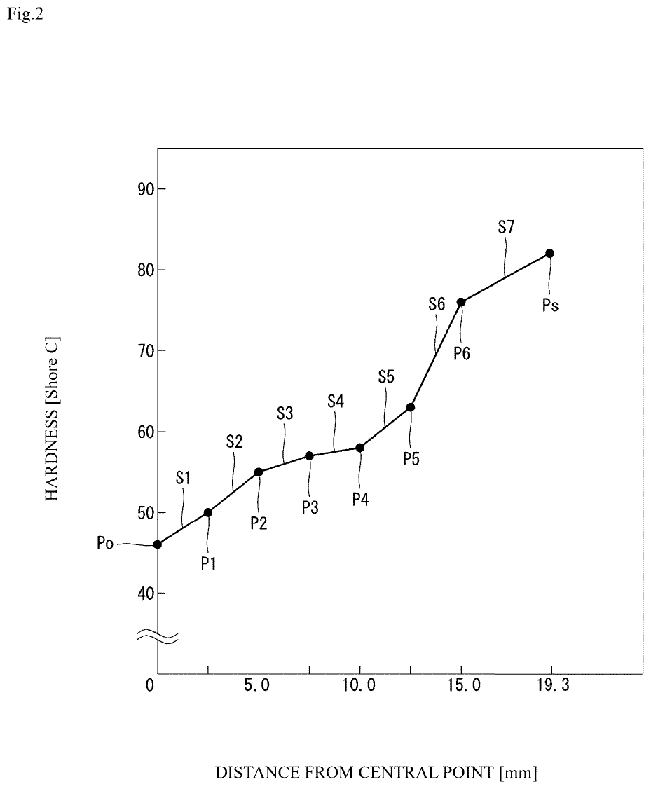

FIG. 2 is a graph showing the hardness distribution of the core 4. In this graph, the horizontal axis indicates a distance from the central point of the core 4, and the vertical axis indicates a hardness (Shore C). The following points are plotted on this graph.

Central point Po
First point P1 whose distance from the central point is 2.5 mm
Second point P2 whose distance from the central point is 5.0 mm
Third point P3 whose distance from the central point is 7.5 mm
Fourth point P4 whose distance from the central point is 10.0 mm
Fifth point P5 whose distance from the central point is 12.5 mm
Sixth point P6 whose distance from the central point is 15.0 mm
Point Ps on the surface of the core 4

In the present specification, the following hardnesses are measured.
Ho: a hardness at the central point Po
H(2.5): a hardness at the first point P1
H(5.0): a hardness at the second point P2
H(7.5): a hardness at the third point P3
H(10.0): a hardness at the fourth point P4
H(12.5): a hardness at the fifth point P5
H(15.0): a hardness at the sixth point P6
Hs: a hardness at the point Ps on the surface

The hardnesses at the central point Po and the first point P1 to the sixth point P6 are measured with a Shore C type hardness scale mounted to an automated hardness meter (trade name “Digi Test II” manufactured by Heinrich Bareiss Prüfgerätebau GmbH). The hardness scale is pressed against the cross-section of a hemisphere obtained by cutting the golf ball 2. The measurement is conducted in an environment of 23° C.

The hardness Hs at the point Ps on the surface is measured with a Shore C type hardness scale mounted to the above-described trade name “Digi Test II”. The hardness scale is pressed against the surface of the core 4. The measurement is conducted in an environment of 23° C.

In the present embodiment, the hardnesses are as follows.
Ho: 46
H(2.5): 50
H(5.0): 55
H(7.5): 57
H(10.0): 58
H(12.5): 63
H(15.0): 76
Hs: 82

In FIG. 2, straight lines S1 to S7 are shown.
S1: a straight line connecting the central point Po and the first point P1
S2: a straight line connecting the first point P1 and the second point P2
S3: a straight line connecting the second point P2 and the third point P3
S4: a straight line connecting the third point P3 and the fourth point P4
S5: a straight line connecting the fourth point P4 and the fifth point P5
S6: a straight line connecting the fifth point P5 and the sixth point P6
S7: a straight line connecting the sixth point P6 and the point Ps on the surface

The straight lines S1 to S7 have slopes A1 to A7, respectively. The calculation expressions of the slopes A1 to A7 are as follows.

$$Slope A 1 of straight line S 1 : ( H ( 2.5 ) - Ho ) / 2.5 = 1.92$$

$$Slope A 2 of straight line S 2 : ( H ( 5. ) - H ( 2.5 ) ) / 2.5 = 1.64$$

$$Slope A 3 of straight line S 3 : ( H ( 7.5 ) - H ( 5. ) ) / 2.5 = 1.$$

$$Slope A 4 of straight line S 4 : ( H ( 10. ) - H ( 7.5 ) ) / 2.5 = 0.4$$

$$Slope A 5 of straight line S 5 : ( H ( 12.5 ) - H ( 10. ) ) / 2.5 = 2.$$

$$Slope A 6 of straight line S 6 : ( H ( 15. ) - H ( 12.5 ) ) / 2.5 = 5.12$$

$$Slope A 7 of straight line S 7 : ( Hs - H ( 15. ) ) / 4.3 = 1.42$$

In the core 4, the slope A1 is 1.00 or more, the slope A2 is 1.00 or more, the slope A5 is 1.50 or more, and the slope A6 is 1.50 or more. The core 4 having this hardness distribution reduces an initial spin rate upon a shot with a driver. The golf ball 2 that includes this core 4 has excellent flight performance. Furthermore, this core 4 contributes to soft feel at impact upon putting.

From the viewpoint of flight performance and feel at impact, the slope A1 is more preferably 1.30 or more and particularly preferably 1.50 or more. From the same viewpoint, the slope A2 is more preferably 1.30 or more and particularly preferably 1.50 or more. From the same viewpoint, the slope A5 is more preferably 1.70 or more and particularly preferably 1.80 or more. From the same viewpoint, the slope A6 is more preferably 2.50 or more and particularly preferably 3.00 or more. From the viewpoint of the durability of the golf ball 2, the slope of each of the straight lines S1 to S7 is preferably 10.00 or less.

In the present embodiment, the slope A3 is smaller than the slope A2, and the slope A4 is smaller than the slope A3. In the core 4, the rate of increase in hardness between the second point P2 and the fourth point P4 is low. When the golf ball 2 is hit with a driver, the energy loss is small in the core 4. The core 4 can contribute to the resilience performance of the golf ball 2. The golf ball 2 has excellent flight performance. From this viewpoint, the difference (A2-A3) between the slope A2 and the slope A3 is preferably 0.10 or more, more preferably 0.20 or more, and particularly preferably 0.25 or more. From the same viewpoint, the difference (A3-A4) between the slope A3 and the slope A4 is preferably 0.10 or more, more preferably 0.20 or more, and particularly preferably 0.25 or more.

As is obvious from FIG. 2, the hardness Hs at the surface is higher than the hardness Ho at the central point Po. The core 4 having a large difference (Hs-Ho) reduces an initial spin rate upon a shot with a driver. The golf ball 2 that includes this core 4 has excellent flight performance. Furthermore, this core 4 contributes to soft feel at impact upon putting. From these viewpoints, the difference (Hs-Ho) is preferably 30 or more, more preferably 32 or more, and particularly preferably 34 or more. From the viewpoint of the resilience performance of the golf ball 2, the difference (Hs-Ho) is preferably 40 or less, more preferably 39 or less, and particularly preferably 38 or less.

By a relatively large amount of the carboxylic acid or the carboxylate being added to the rubber composition of the core 4, the hardness distribution shown in FIG. 2 can be achieved. The hardness distribution shown in FIG. 2 can also be achieved by adjustment of the crosslinking temperature and the crosslinking time of the core 4. For example, a preferable hardness distribution of the core 4 can be achieved by crosslinking under conditions where the crosslinking temperature is 160° C. and the crosslinking time is 10 minutes or longer and 20 minutes or shorter.

### [Mid Layer]

The mid layer 6 is positioned outside the core 4. In the present embodiment, the mid layer 6 is in contact with the core 4. The mid layer 6 is formed from a resin composition. In the present embodiment, the mid layer 6 is formed from a thermoplastic resin composition.

### [Base Resin]

Examples of the base resin of the resin composition of the mid layer 6 include ionomer resins, polyamide resins, thermoplastic polyester elastomers, thermoplastic polyurethane elastomers, thermoplastic polyolefin elastomers, and thermoplastic polystyrene elastomers. Ionomer resins are particularly preferable. Ionomer resins are highly elastic. The golf ball 2 that includes the mid layer 6 containing an ionomer resin has excellent resilience performance. Furthermore, by this mid layer 6, an appropriate hardness distribution of the sphere consisting of the core 4 and the mid layer 6 is achieved. In the case where an ionomer resin and another resin are used in combination, the principal component of the base resin is the ionomer resin.

Examples of preferable ionomer resins include a binary ionomer resin and a ternary ionomer resin. The binary ionomer resin is a binary copolymer that is formed with an α-olefin and an α,β-unsaturated carboxylic acid having 3 to 8 carbon atoms. At least some of the carboxyl groups of this binary copolymer are neutralized with metal ions. A preferable binary ionomer resin contains 80% by mass or more and 90% by mass or less of an α-olefin, and 10% by mass or more and 20% by mass or less of an α,β-unsaturated carboxylic acid. This binary ionomer resin has excellent resilience performance. The ternary ionomer resin is a ternary copolymer that is formed with an α-olefin, an α,β-unsaturated carboxylic acid having 3 to 8 carbon atoms, and an α,β-unsaturated carboxylic acid ester having 2 to 22 carbon atoms. At least some of the carboxyl groups of this ternary copolymer are neutralized with metal ions. A preferable ternary ionomer resin contains 70% by mass or more and 85% by mass or less of an α-olefin, 5% by mass or more and 30% by mass or less of an α,β-unsaturated carboxylic acid, and 1% by mass or more and 25% by mass or less of an α,β-unsaturated carboxylic acid ester. This ternary ionomer resin has excellent resilience performance. For the binary ionomer resin and the ternary ionomer resin, preferable α-olefins are ethylene and propylene, while preferable α,β-unsaturated carboxylic acids are acrylic acid and methacrylic acid. Preferable copolymers are a binary copolymer formed with ethylene and acrylic acid and a binary copolymer formed with ethylene and methacrylic acid.

Examples of metal ions for use in neutralization of the carboxyl groups in the ionomer resin include sodium ions, potassium ions, lithium ions, zinc ions, calcium ions, magnesium ions, aluminum ions, and neodymium ions. The neutralization may be carried out with two or more types of metal ions. Particularly suitable metal ions from the viewpoint of resilience performance and durability of the golf ball 2 are sodium ions, zinc ions, lithium ions, and magnesium ions.

Specific examples of ionomer resins include trade names “HIMILAN 1555”, “HIMILAN 1557”, “HIMILAN 1605”, “HIMILAN 1702”, “HIMILAN 1706”, “HIMILAN 1707”, “HIMILAN 1855”, “HIMILAN 1856”, “HIMILAN 8150”, “HIMILAN AM7311”, “HIMILAN AM7315”, “HIMILAN AM7317”, “HIMILAN AM7327”, “HIMILAN AM7329”, and “HIMILAN AM7337”, manufactured by DOW-MITSUI POLYCHEMICALS CO., LTD.; trade names “SURLYN 6120”, “SURLYN 6910”, “SURLYN 7930”, “SURLYN 7940”, “SURLYN 8140”, “SURLYN 8150”, “SURLYN 8940”, “SURLYN 8945”, “SURLYN 9120”, “SURLYN 9150”, “SURLYN 9320”, “SURLYN 9910”, “SURLYN 9945”, “SURLYN AD8546”, “HPF1000”, and “HPF2000”, manufactured by E.I. du Pont de Nemours and Company; and trade names “IOTEK 7010”, “IOTEK 7030”, “IOTEK 7510”, “IOTEK 7520”, “IOTEK 8000”, and “IOTEK 8030”, manufactured by ExxonMobil Chemical Company. Two or more ionomer resins may be used in combination.

The ratio of the amount of the ionomer resin to that of the base resin of the mid layer 6 is preferably 60% by mass or more, more preferably 70% by mass or more, and particularly preferably 80% by mass or more. This ratio may be 100% by mass.

### [Additives]

The resin composition of the mid layer 6 may contain a coloring agent, a filler, a dispersant, an antioxidant, an ultraviolet absorber, a light stabilizer, a fluorescent material, a fluorescent brightener, etc., in an adequate amount. A typical filler is barium sulfate. In the case where the hue of the golf ball 2 is white, a typical coloring agent is titanium dioxide.

### [Thickness]

The mid layer 6 preferably has a thickness Tm of 0.5 mm or more and 2.0 mm or less. The golf ball 2 in which the thickness Tm is 0.5 mm or more has excellent resilience performance. From this viewpoint, the thickness Tm is more preferably 0.7 mm or more and particularly preferably 0.8 mm or more. The golf ball 2 in which the thickness Tm is 2.0 mm or less has excellent feel at impact upon a shot with a driver. From this viewpoint, the thickness Tm is more preferably 1.5 mm or less and particularly preferably 1.3 mm or less. The thickness Tm is measured at a position immediately below the land 12.

### [Hardness]

The mid layer 6 preferably has a hardness Hm of 50 or more and 90 or less. The golf ball 2 in which the hardness Hm is 50 or more has excellent resilience performance. From this viewpoint, the hardness Hm is more preferably 60 or more and particularly preferably 65 or more. The golf ball 2 in which the hardness Hm is 90 or less has excellent feel at impact. From this viewpoint, the hardness Hm is more preferably 80 or less and particularly preferably 75 or less.

The hardness Hm of the mid layer 6 is measured according to the standards of “ASTM-D 2240-68”. The hardness Hm is measured with a Shore D type hardness scale mounted to an automated hardness meter (trade name “Digi Test II” manufactured by Heinrich Bareiss Prüfgerätebau GmbH). For the measurement, a sheet that is formed by hot press, is formed from the same material as that of the mid layer 6, and has a thickness of about 2 mm, is used. Prior to the measurement, the sheet is kept at 23° C. for two weeks. At the time of measurement, three sheets are stacked.

### [Melt Flow Rate]

The resin composition of the mid layer 6 preferably has a melt flow rate Mm of 3.0 g/10 min or more. The mid layer 6 can be easily molded from this resin composition. From this viewpoint, the melt flow rate Mm is more preferably 4.0 g/10 min or more and particularly preferably 4.5 g/10 min or more.

### [Bending Stiffness]

The mid layer 6 preferably has a bending stiffness Fm of 300 MPa or more. The golf ball 2 in which the bending stiffness Fm is 300 MPa or more has excellent resilience performance. From this viewpoint, the bending stiffness Fm is more preferably 310 MPa or more and particularly preferably 315 MPa or more. From the viewpoint of the feel at impact of the golf ball 2, the bending stiffness Fm is preferably 400 MPa or less, more preferably 380 MPa or less, and particularly preferably 350 MPa or less.

### [Cover]

The cover 8 is positioned outside the mid layer 6. In the present embodiment, the cover 8 is in contact with the mid layer 6. The golf ball 2 may have an adhesive layer between the mid layer 6 and the cover 8. The cover 8 can be firmly joined to the mid layer 6 via this adhesive layer. The cover 8 is formed from a resin composition. In the present embodiment, the cover 8 is formed from a thermoplastic resin composition.

### [Base Resin]

Examples of the base resin of the resin composition of the cover 8 include ionomer resins, thermoplastic polystyrene elastomers, thermoplastic polyester elastomers, thermoplastic polyamide elastomers, thermoplastic polyurethane elastomers, and thermoplastic polyolefin elastomers. Ionomer resins are particularly preferable. Ionomer resins are highly elastic. The golf ball 2 that includes the cover 8 containing an ionomer resin has excellent resilience performance. The golf ball 2 has excellent flight performance upon a shot with a driver.

An ionomer resin and another resin may be used in combination. In this case, from the viewpoint of resilience performance, the ionomer resin is contained as the principal component of the base resin. The ratio P(I) of the amount of the ionomer resin to the total amount of the base resin is preferably 60% by mass or more, more preferably 70% by mass or more, and particularly preferably 75% by mass or more. The ratio P(I) may be 100% by mass.

The ionomer resins described above for the mid layer 6 can also be applied to the cover 8. In particular, a zinc ion-neutralized ionomer resin is preferable. The cover 8 containing a zinc ion-neutralized ionomer resin can achieve both a low hardness and scuff resistance. From this viewpoint, the ratio P(Zn) of the amount of the zinc ion-neutralized ionomer resin to the total amount of the base resin is preferably 60% by mass or more, more preferably 80% by mass or more, and particularly preferably 85% by mass or more. The ratio P(Zn) may be 100% by mass.

From the same viewpoint, the ratio P(Zn/I) of the amount of the zinc ion-neutralized ionomer resin to the total amount of the ionomer resin is preferably 90% by mass or more, more preferably 95% by mass or more, and particularly preferably 98% by mass or more. The ratio P(Zn/I) may be 100% by mass.

The resin composition of the cover 8 preferably contains a first zinc ion-neutralized ionomer resin and a second zinc ion-neutralized ionomer resin whose components are different from those of the first zinc ion-neutralized ionomer resin. A cover 8 having appropriate physical properties can be obtained from a resin composition in which two or more zinc ion-neutralized ionomer resins are blended.

From the viewpoint of scuff resistance, it is preferable that the amount of a sodium ion-neutralized ionomer resin in the resin composition of the cover 8 is smaller. The ratio P(Na) of the amount of the sodium ion-neutralized ionomer resin to the total amount of the base resin is preferably 5% by mass or less. An ideal ratio P(Na) is 0% by mass.

Examples of a preferable resin that can be used in combination with an ionomer resin include
(1) an unneutralized resin that is a binary copolymer of an olefin and an α,β-unsaturated carboxylic acid, and
(2) an unneutralized resin that is a ternary copolymer of an olefin, an α,β-unsaturated carboxylic acid, and an α,β-unsaturated carboxylic acid ester.
   The binary copolymer (1) and the ternary copolymer (2) contribute to the fluidity of the melted resin composition. The cover 8 containing the binary copolymer (1) or the ternary copolymer (2) has excellent moldability.

The ratio P(n) of the total amount of the unneutralized resin (1) that is a binary copolymer and the unneutralized resin (2) that is a ternary copolymer to the total amount of the base resin is preferably 10% by mass or more and 40% by mass or less. The cover 8 having a ratio P(n) of 10% by mass or more has excellent moldability. From this viewpoint, the ratio P(n) is more preferably 13% by mass or more and particularly preferably 15% by mass or more. The cover 8 having a ratio P(n) of 40% by mass or less has excellent resilience performance. From this viewpoint, the ratio P(n) is more preferably 30% by mass or less and particularly preferably 25% by mass or less.

Specific examples of the unneutralized binary copolymer (1) include: trade names “NUCREL N1050H”, “NUCREL N2050H”, “NUCREL N1110H”, and “NUCREL NO200H” manufactured by DOW-MITSUI POLYCHEMICALS CO., LTD.; and trade name “PRIMACOR 5980I” manufactured by the Dow Chemical Company. Specific examples of the unneutralized ternary copolymer (2) include: trade names “NUCREL AN4318” and “NUCREL AN4319” manufactured by DOW-MITSUI POLYCHEMICALS CO., LTD.; and trade names “PRIMACOR AT310” and “PRIMACOR AT320” manufactured by the Dow Chemical Company.

The resin composition of the cover 8 may contain a styrene block-containing thermoplastic elastomer together with an ionomer resin. The styrene block-containing thermoplastic elastomer can contribute to the low hardness of the cover 8.

The styrene block-containing thermoplastic elastomer contains a polystyrene block as a hard segment, and a soft segment. A typical soft segment is a diene block. Examples of compounds for the diene block include butadiene, isoprene, 1,3-pentadiene, and 2,3-dimethyl-1,3-butadiene. Butadiene and isoprene are preferable. Two or more of the compounds may be used in combination.

Examples of styrene block-containing thermoplastic elastomers include styrene-butadiene-styrene block copolymers (SBS), styrene-isoprene-styrene block copolymers (SIS), styrene-isoprene-butadiene-styrene block copolymers (SIBS), hydrogenated SBS, hydrogenated SIS, and hydrogenated SIBS. Examples of hydrogenated SBS include styrene-ethylene-butylene-styrene block copolymers (SEBS). Examples of hydrogenated SIS include styrene-ethylene-propylene-styrene block copolymers (SEPS). Examples of hydrogenated SIBS include styrene-ethylene-ethylene-propylene-styrene block copolymers (SEEPS).

In the present disclosure, styrene block-containing thermoplastic elastomers include an alloy of an olefin and one or more members selected from the group consisting of SBS, SIS, SIBS, SEBS, SEPS, and SEEPS. The olefin component in the alloy is presumed to contribute to improvement of compatibility with another base resin. The alloy can contribute to the resilience performance of the golf ball 2. An olefin having 2 to 10 carbon atoms is preferable. Examples of suitable olefins include ethylene, propylene, butene, and pentene. Ethylene and propylene are particularly preferable.

Specific examples of polymer alloys include trade names “TEFABLOC T3221C”, “TEFABLOC T3339C”, “TEFABLOC SJ4400N”, “TEFABLOC SJ5400N”, “TEFABLOC SJ6400N”, “TEFABLOC SJ7400N”, “TEFABLOC SJ8400N”, “TEFABLOC SJ9400N”, and “TEFABLOC SR04”, manufactured by Mitsubishi Chemical Corporation. Other specific examples of styrene block-containing thermoplastic elastomers include trade name “EPOFRIEND A1010” manufactured by Daicel Corporation, and trade name “SEPTON HG-252” manufactured by Kuraray Co., Ltd.

### [Additives]

The resin composition of the cover 8 may contain a coloring agent, a filler, a dispersant, an antioxidant, an ultraviolet absorber, a light stabilizer, a fluorescent material, a fluorescent brightener, etc., in an adequate amount. A typical filler is barium sulfate. In the case where the hue of the golf ball 2 is white, a typical coloring agent is titanium dioxide.

### [Thickness]

The cover 8 preferably has a thickness Tc of 0.50 mm or more and 2.00 mm or less. The golf ball 2 in which the thickness Tc is 0.50 mm or more has excellent moldability and durability. From these viewpoints, the thickness Tc is more preferably 0.70 mm or more and particularly preferably 0.90 mm or more. The golf ball 2 in which the thickness Tc is 2.00 mm or less has excellent resilience performance. From this viewpoint, the thickness Tc is more preferably 1.50 mm or less and particularly preferably 1.20 mm or less. The thickness Tc is measured at a position immediately below the land 12.

### [Hardness]

The cover 8 preferably has a hardness Hc of 40 or more and 50 or less. The golf ball 2 in which the hardness Hc is 40 or more has excellent resilience performance. From this viewpoint, the hardness Hc is more preferably 42 or more and particularly preferably 43 or more. The golf ball 2 in which the hardness Hc is 50 or less has excellent feel at impact upon putting. From this viewpoint, the hardness Hc is more preferably 48 or less and particularly preferably 47 or less. The hardness Hc of the cover 8 is measured by the same measurement method as for the hardness Hm of the mid layer 6.

### [Melt Flow Rate]

The resin composition of the cover 8 preferably has a melt flow rate Mc of 8.0 g/10 min or more. The cover 8 can be easily molded from this resin composition. From this viewpoint, the melt flow rate Mc is more preferably 9.0 g/10 min or more and particularly preferably 10.0 g/10 min or more.

The melt flow rate Mm and the melt flow rate Mc are measured according to the standards of “JIS K 7210-1:2014”. The measurement conditions are as follows.
Reference: mass (method A)
Temperature: 190° C.
Load: 2.16 Kg
Die: standard
   “Flowtester CFT-100C” manufactured by SHIMADZU CORPORATION is exemplified as a device suitable for the measurement.

The product (Mc*Tc) of the melt flow rate Mc (g/10 min) and the thickness Tc (mm) of the cover 8 is preferably 10.0 or more. The cover 8 in which this product is 10.0 or more can be easily molded. From this viewpoint, this product is more preferably 10.2 or more and particularly preferably 10.4 or more.

### [Bending Stiffness]

The cover 8 preferably has a bending stiffness Fc of 75 MPa or less. The golf ball 2 in which the bending stiffness Fc is 75 MPa or less has excellent feel at impact upon putting. From this viewpoint, the bending stiffness Fc is more preferably 70 MPa or less and particularly preferably 65 MPa or less. From the viewpoint of the resilience performance of the golf ball 2, the bending stiffness Fc is preferably 40 MPa or more.

The bending stiffness Fm and the bending stiffness Fc are measured according to the standards of “JIS K 7106”. A test piece having a thickness of 2 mm, a width of 20 mm, and a length of 100 mm is subjected to the measurement. Prior to the measurement, the test piece is kept in an environment having a temperature of 23±2° C. and a relative humidity of 50±5% for 14 days. The measurement conditions are as follows.
Temperature: 23±2° C.
Relative humidity: 50±5%
Distance between fulcrums: 50 mm
Bending speed: 60°/min
Bending angle: 3°, 6°, 9°, and 12°
   An Olsen type stiffness tester manufactured by Toyo Seiki Seisaku-sho, Ltd. is used as a testing machine suitable for the measurement. The measurement results are plotted on a graph with the load scale on the vertical axis and the bending angle on the horizontal axis. The slope of the first-order approximation curve of this plot is obtained, and this slope is multiplied by 8.7078 and then divided by the cube of the thickness (cm) of the test piece to calculate a bending stiffness.

### [Golf Ball]

The golf ball 2 preferably has a diameter of 40 mm or more and 45 mm or less. From the viewpoint of conformity to the rules established by the United States Golf Association (USGA), the diameter is particularly preferably 42.67 mm or more. From the viewpoint of suppression of air resistance, the diameter is more preferably 44 mm or less and particularly preferably 42.80 mm or less.

The golf ball 2 preferably has a mass of 40 g or more and 50 g or less. From the viewpoint of attainment of great inertia, the mass is more preferably 44 g or more and particularly preferably 45.00 g or more. From the viewpoint of conformity to the rules established by the USGA, the mass is particularly preferably 45.93 g or less.

The golf ball 2 preferably has an amount of compressive deformation C2 of 3.0 mm or more. The golf ball 2 having an amount of compressive deformation C2 of 3.0 mm or more has excellent feel at impact upon putting. From this viewpoint, the amount of compressive deformation C2 is more preferably 3.2 mm or more and particularly preferably 3.3 mm or more. From the viewpoint of resilience performance, the amount of compressive deformation C2 is preferably 4.5 mm or less, more preferably 4.2 mm or less, and particularly preferably 4.0 mm or less.

The amount of compressive deformation C2 is measured with the aforementioned YAMADA type compression tester “SCH”. In the tester, the golf ball 2 is placed on a rigid plate made of metal. Next, a cylinder made of metal gradually descends toward the golf ball 2. The golf ball 2 squeezed between the bottom face of the cylinder and the hard plate becomes deformed. A movement distance of the cylinder, starting from the state in which an initial load of 98 N is applied to the golf ball 2 up to the state in which a final load of 1274 N is applied thereto, is measured. A movement speed of the cylinder until the initial load is applied is 0.83 mm/s. A movement speed of the cylinder after the initial load is applied until the final load is applied is 1.67 mm/s.

### EXAMPLES

### Example 1

A rubber composition G was obtained by kneading 100 parts by mass of a high-cis polybutadiene (trade name “BR-730”, manufactured by JSR Corporation), 28.5 parts by mass of zinc acrylate (trade name “ZN-DA90S”, manufactured by NISSHOKU TECHNO FINE CHEMICAL CO., LTD.), 10 parts by mass of zinc oxide (product of INDO LYSAGHT), 10.7 parts by mass of barium sulfate (product number “BD”, manufactured by SAKAI CHEMICAL INDUSTRY CO., LTD.), 1.0 part by mass of dicumyl peroxide (trade name “PERCUMYL D”, manufactured by NOF CORPORATION), 3.5 parts by mass of benzoic acid (product of Tokyo Chemical Industry Co., Ltd.), and 1.2 parts by mass of a pentachlorothiophenol zinc salt (product number “PCTP-Zn”, manufactured by FUJIFILM Wako Pure Chemical Corporation). This rubber composition G was placed into a mold including upper and lower mold halves each having a hemispherical cavity, and heated to obtain a core with a diameter of 38.6 mm. The crosslinking temperature was 160° C. The crosslinking time was 20 minutes. The hardness distribution of the core is shown in Table 1 below.

A resin composition 1 was obtained by kneading 20 parts by mass of an ionomer resin (aforementioned “HIMILAN AM7329”), 80 parts by mass of another ionomer resin (aforementioned “HIMILAN AM7337”), 6 parts by mass of barium sulfate, and 4 parts by mass of titanium dioxide with a twin-screw kneading extruder. The core was placed into a mold including upper and lower mold halves each having a hemispherical cavity. The melted resin composition 1 was injected so as to cover the core in an injection molding machine to form a mid layer. The thickness of the mid layer was 1.00 mm.

A resin composition E was obtained by kneading 80 parts by mass of an ionomer resin (aforementioned “HIMILAN AM7327”), 10 parts by mass of another ionomer resin (aforementioned “HIMILAN 1557”), 10 parts by mass of a copolymer (aforementioned “NUCREL N1050H”), and 4 parts by mass of titanium dioxide with a twin-screw kneading extruder. The sphere consisting of the core and the mid layer was placed into a mold including upper and lower mold halves each having a hemispherical cavity. The melted resin composition E was injected so as to cover the sphere in an injection molding machine to form a cover. The thickness of the cover was 1.05 mm.

A clear paint including a two-component curing type polyurethane as a base material was applied to this cover to obtain a golf ball of Example 1 having a diameter of about 42.7 mm and a mass of about 45.5 g.

### Examples 2 to 10 and Comparative Examples 1 to 10

Golf balls of Examples 2 to 10 and Comparative Examples 1 to 10 were obtained in the same manner as Example 1, except that the specifications of the core, the mid layer, and the cover were set as shown in Tables 6 to 9 below. The specifications of the core are shown in Tables 1 and 2 below. The composition of the mid layer is shown in Table 3 below. The composition of the cover is shown in Tables 4 and 5 below.

TABLE 1
Specifications of core

| | A | B | C | D | E |
|---|---|---|---|---|---|
| Polybutadiene | 100 | 100 | 100 | 100 | 100 |
| Zinc acrylate | 25.0 | 22.7 | 24.5 | 20.0 | 28.9 |
| Zinc oxide | 5 | 5 | 10 | 10 | 10 |
| Barium sulfate | 18.3 | 19.0 | 12.5 | 14.1 | 10.4 |
| Dicumyl peroxide | 0.9 | 0.9 | 1.2 | 0.9 | 1.0 |
| YOSHINOX BB* | 1.0 | | | | |
| 4-Methoxyphenol | | | 0.1 | | |
| Benzoic acid | | | 2.0 | 2.0 | 3.0 |
| Pentachlorothiophenol | 1.2 | 0.4 | 0.3 | 0.8 | 1.0 |
| zinc salt | | | | | |
| Diameter [mm] | 38.6 | 38.6 | 38.6 | 38.6 | 38.6 |
| Compressive deformation | 4.10 | 4.20 | 4.25 | 4.40 | 4.55 |
| Dc [mm] | | | | | |
| Hardness | 63 | 60 | 64 | 52 | 47 |
| [Shore C] Ho | | | | | |
| H2.5 | 65 | 63 | 68 | 59 | 53 |
| H5.0 | 68 | 65 | 72 | 61 | 57 |
| H7.5 | 69 | 67 | 74 | 63 | 59 |
| H10.0 | 70 | 67 | 75 | 64 | 60 |
| H12.5 | 72 | 73 | 80 | 69 | 67 |
| H15.0 | 73 | 73 | 83 | 74 | 76 |
| Hs | 75 | 78 | 84 | 79 | 79 |
| Hs − Ho | 12 | 18 | 20 | 27 | 32 |
| Slope [/mm] A1 | 0.80 | 1.12 | 1.60 | 2.72 | 2.30 |
| A2 | 1.20 | 0.88 | 1.60 | 0.88 | 1.96 |
| A3 | 0.40 | 0.60 | 0.80 | 0.60 | 0.67 |
| A4 | 0.40 | 0.20 | 0.40 | 0.60 | 0.18 |
| A5 | 0.80 | 2.40 | 2.00 | 2.00 | 2.80 |
| A6 | 0.40 | 0.00 | 1.20 | 2.00 | 3.78 |
| A7 | 0.47 | 1.16 | 0.23 | 1.16 | 0.74 |

*4,4′-butylidenebis(3-methyl-6-tert-butylphenol)

TABLE 2
Specifications of core

| | F | G | H | I | J |
|---|---|---|---|---|---|
| Polybutadiene | 100 | 100 | 100 | 100 | 100 |
| Zinc acrylate | 30.1 | 28.5 | 27.7 | 26.9 | 26 |
| Zinc oxide | 10 | 10 | 10 | 10 | 10 |
| Barium sulfate | 10.1 | 10.7 | 11.0 | 11.3 | 11.6 |
| Dicumyl peroxide | 1.0 | 1.0 | 1.0 | 1.0 | 1.0 |
| Benzoic acid | 3.5 | 3.5 | 3.5 | 3.5 | 3.5 |
| Pentachlorothiophenol | 1.2 | 1.2 | 1.2 | 1.2 | 1.2 |
| zinc salt | | | | | |
| Diameter [mm] | 38.6 | 38.6 | 38.6 | 38.6 | 38.6 |
| Compressive deformation | 4.50 | 4.70 | 4.80 | 4.90 | 5.00 |
| Dc [mm] | | | | | |
| Hardness | 47 | 46 | 45 | 45 | 44 |
| [Shore C] Ho | | | | | |
| H2.5 | 52 | 50 | 50 | 49 | 48 |
| H5.0 | 56 | 55 | 54 | 53 | 53 |
| H7.5 | 58 | 57 | 56 | 56 | 55 |
| H10.0 | 59 | 58 | 57 | 57 | 56 |
| H12.5 | 64 | 63 | 62 | 62 | 61 |
| H15.0 | 77 | 76 | 75 | 74 | 74 |
| Hs | 83 | 82 | 81 | 81 | 80 |
| Hs − Ho | 36 | 36 | 36 | 36 | 36 |
| Slope [/mm] A1 | 1.92 | 1.92 | 1.92 | 1.63 | 1.92 |
| A2 | 1.64 | 1.64 | 1.64 | 1.64 | 1.64 |
| A3 | 1.00 | 1.00 | 1.00 | 1.00 | 1.00 |
| A4 | 0.40 | 0.40 | 0.40 | 0.40 | 0.40 |
| A5 | 2.00 | 2.00 | 2.00 | 2.00 | 2.00 |
| A6 | 5.12 | 5.12 | 5.12 | 5.12 | 5.12 |
| A7 | 1.42 | 1.42 | 1.42 | 1.42 | 1.44 |

TABLE 3
Specifications of mid layer

| | Comp. | Comp. | Comp. |
|---|---|---|---|
| | 1 | 2 | 3 |
| HIMILAN AM7329 | 20 | 50 | |
| HIMILAN AM7337 | 80 | 45 | 80 |
| HIMILAN AM7327 | | 5 | 20 |
| Barium sulfate | 6 | 6 | 6 |
| Titanium dioxide | 4 | 4 | 4 |
| Melt flow rate | 4.9 | 5.2 | 5.4 |
| Mm [g/10 min] | | | |
| Bending stiffness | 343 | 320 | 302 |
| Fm [MPa] | | | |
| Hardness | 69 | 67 | 64 |
| [Shore D] | | | |

TABLE 4
Specifications of cover

| | Comp. | Comp. | Comp. | Comp. | Comp. |
|---|---|---|---|---|---|
| | A | B | C | D | E |
| HIMILAN 1855 | 30 | | | | |
| HIMILAN AM7327 | | 35 | 50 | 50 | 80 |
| HIMILAN 1555 | | | | | |
| HIMILAN 1557 | 50 | 45 | 35 | 30 | 10 |
| NUCREL N1050H | 20 | 20 | 15 | 15 | 10 |
| TEFABLOC | | | | 5 | |
| Titanium dioxide | 4 | 4 | 4 | 4 | 4 |
| P(I) [% by mass] | 80 | 80 | 85 | 80 | 90 |
| P(Na) [% by mass] | 0 | 0 | 0 | 0 | 0 |
| P(Zn) [% by mass] | 80 | 80 | 85 | 80 | 90 |
| P(Zn/I) [% by mass] | 100 | 100 | 100 | 100 | 100 |
| P(n) [% by mass] | 20 | 20 | 15 | 15 | 10 |
| Bending stiffness | 81 | 71 | 67 | 54 | 47 |
| Fc [MPa] | | | | | |
| Melt flow rate Mc | 10.0 | 11.3 | 10.4 | 10.4 | 10.0 |
| [g/10 min] | | | | | |
| Hardness | 57 | 52 | 50 | 47 | 45 |
| [Shore D] | | | | | |

TABLE 5
Specifications of cover

| | Comp. | Comp. | Comp. | Comp. |
|---|---|---|---|---|
| | F | G | H | I |
| HIMILAN 1855 | | | | 25 |
| HIMILAN AM7327 | 87 | 80 | 80 | 75 |
| HIMILAN 1555 | | 5 | 10 | |
| HIMILAN 1557 | | 5 | | |
| NUCREL N1050H | 10 | 10 | 10 | |
| TEFABLOC | 3 | | | |
| Titanium dioxide | 4 | | | |
| P(I) [% by mass] | 87 | 90 | 90 | 100 |
| P(Na) [% by mass] | 0 | 5 | 10 | 0 |
| P(Zn) [% by mass] | 87 | 85 | 80 | 100 |
| P(Zn/I) [% by mass] | 100 | 94 | 89 | 100 |
| P(n) [% by mass] | 10 | 10 | 10 | 0 |
| Bending stiffness | 40 | 50 | 51 | 51 |
| Fc [MPa] | | | | |
| Melt flow rate Mc | 10.1 | 10.2 | 10.4 | 6.3 |
| [g/10 min] | | | | |
| Hardness | 42 | 45 | 45 | 45 |
| [Shore D] | | | | |

The neutralizing metal ions of the ionomer resins shown in Tables 4 and 5 are as follows.
HIMILAN 1855: zinc ion
HIMILAN AM7327: zinc ion
HIMILAN 1555: sodium ion
HIMILAN 1557: zinc ion

### [Scuff Resistance]

A sand wedge (trade name “XXIO 13 (made in 2023)”, manufactured by Sumitomo Rubber Industries, Ltd., shaft hardness: R) was attached to a swing machine manufactured by Golf Laboratories, Inc. A golf ball was hit with this sand wedge under a condition of a head speed of 36 m/sec. The appearance of the cover was visually observed to determine scuff resistance. The results are shown in Tables 6 to 9 below.

### [Moldability]

A golf ball was obtained with the injection pressure of the injection molding machine being set to a value lower by 10% during cover molding. The appearance of the cover was visually observed to determine the presence or absence of bareness. The results are shown in Tables 6 to 9 below.

### [Flight Performance]

A driver (W #1, trade name “XXIO PRIME 12 (made in 2023)”, manufactured by Sumitomo Rubber Industries, Ltd., shaft hardness: R) was attached to a swing machine manufactured by Golf Laboratories, Inc. A golf ball was hit with this driver under a condition of a head speed of 30 m/sec, and the distance from the launch point to the stop point was measured. During the test, the weather was almost windless. The average value of flight distances obtained by 12 measurements was calculated. Furthermore, the average value was rated based on the following criteria.
A: 155.0 yards or more
B: 154.5 yards or more but less than 155.0 yards
C: 154.0 yards or more but less than 154.5 yards
D: less than 154.0 yards
   These results are shown in Tables 6 to 9 below.

### [Feel at Impact]

Ten golf players putted golf balls and were asked about feel at impact. The golf balls were rated according to the following criteria based on the number of golf players who answered “the feel at impact was good”.
A: 8 or more
B: 6 or more but 7 or less
C: 4 or more but 5 or less
D: 3 or less
   The results are shown in Tables 6 to 9 below.

### [Overall Evaluation]

Combined performance of the golf balls was rated according to the following criteria.
A: Scuff resistance and moldability are “Good”, and flight distance evaluation and evaluation of feel at impact are “A”.
B: Scuff resistance and moldability are “Good”, and flight distance evaluation and evaluation of feel at impact are neither “C” nor “D”, and flight distance evaluation or evaluation of feel at impact is “B”.
C: Scuff resistance and moldability are “Good”, flight distance evaluation and evaluation of feel at impact are not “D”, and flight distance evaluation or evaluation of feel at impact is “C”.
D: Scuff resistance or moldability is “Bad”, or flight distance evaluation or evaluation of feel at impact is “D”.

The results are shown in Tables 6 to 9 below.

TABLE 6
Evaluation results

| | Comparative | Comparative | Comparative | Comparative | |
|---|---|---|---|---|---|
| | Example 1 | Example 2 | Example 3 | Example 4 | Example 2 |
| Core | A | B | C | D | E |
| C1 [mm] | 4.1 | 4.2 | 4.2 | 4.3 | 4.4 |
| Hs − Ho [Shore C] | 12 | 18 | 20 | 27 | 32 |
| A1 [/mm] | 0.80 | 1.12 | 1.60 | 2.72 | 2.30 |
| A2 [/mm] | 1.20 | 0.88 | 1.60 | 0.88 | 1.96 |
| A5 [/mm] | 0.80 | 2.40 | 2.00 | 2.00 | 2.80 |
| A6 [/mm] | 0.40 | 0.00 | 1.20 | 2.00 | 3.78 |
| Mid layer | Comp. 1 | Comp. 1 | Comp. 1 | Comp. 1 | Comp. 1 |
| Hm [Shore D] | 69 | 69 | 69 | 69 | 69 |
| Tm [mm] | 1.00 | 1.00 | 1.00 | 1.00 | 1.00 |
| Mm [g/10 min] | 4.9 | 4.9 | 4.9 | 4.9 | 4.9 |
| Fm [MPa] | 343 | 343 | 343 | 343 | 343 |
| Cover | Comp. E | Comp. E | Comp. E | Comp. E | Comp. E |
| P(I) [% by mass] | 90 | 90 | 90 | 90 | 90 |
| P(Na) [% by mass] | 0 | 0 | 0 | 0 | 0 |
| P(Zn) [% by mass] | 90 | 90 | 90 | 90 | 90 |
| P(Zn/I) [% by mass] | 100 | 100 | 100 | 100 | 100 |
| P(n) [% by mass] | 10 | 10 | 10 | 10 | 10 |
| Hc [Shore D] | 45 | 45 | 45 | 45 | 45 |
| Tc [mm] | 1.05 | 1.05 | 1.05 | 1.05 | 1.05 |
| Mc [g/10 min] | 10.0 | 10.0 | 10.0 | 10.0 | 10.0 |
| Fc [MPa] | 47 | 47 | 47 | 47 | 47 |
| Mc * Tc | 10. | 10.4 | 10.4 | 10.4 | 10.4 |
| C2 [mm] | 3.4 | 3.4 | 3.4 | 3.4 | 3.4 |
| Scuff resistance | Good | Good | Good | Good | Good |
| Moldability | Good | Good | Good | Good | Good |
| Flight distance [Yards] | 153.3 | 153.7 | 153.9 | 154.1 | 154.8 |
| Flight distance evaluation | D | D | D | C | B |
| Evaluation of feel at impact | A | A | A | A | A |
| Overall evaluation | D | D | D | C | B |

TABLE 7
Evaluation results

| | Example | Comparative | Example | Example | Example |
|---|---|---|---|---|---|
| | 1 | Example 5 | 3 | 4 | 5 |
| Core | G | G | J | I | H |
| C1 [mm] | 4.7 | 4.7 | 5.0 | 4.9 | 4.8 |
| Hs − Ho [Shore C] | 36 | 36 | 36 | 36 | 36 |
| A1 [/mm] | 1.9 | 1.92 | 1.92 | 1.63 | 1.92 |
| A2 [/mm] | 1.64 | 1.64 | 1.64 | 1.64 | 1.64 |
| A5 [/mm] | 2.00 | 2.00 | 2.00 | 2.00 | 2.00 |
| A6 [/mm] | 5.12 | 5.12 | 5.12 | 5.12 | 5.12 |
| Mid layer | Comp. 1 | Comp. 1 | Comp. 1 | Comp. 1 | Comp. 1 |
| Hm [Shore D] | 69 | 69 | 69 | 69 | 69 |
| Tm [mm] | 1.00 | 1.00 | 1.00 | 1.00 | 1.00 |
| Mm [g/10 min] | 4.9 | 4.9 | 4.9 | 4.9 | 4.9 |
| Fm [MPa] | 343 | 343 | 343 | 343 | 343 |
| Cover | Comp. E | Comp. A | Comp. B | Comp. C | Comp. D |
| P(I) [% by mass] | 90 | 80 | 80 | 85 | 80 |
| P(Na) [% by mass] | 0 | 0 | 0 | 0 | 0 |
| P(Zn) [% by mass] | 90 | 80 | 80 | 85 | 80 |
| P(Zn/I) [% by mass] | 100 | 100 | 100 | 100 | 100 |
| P(n) [% by mass] | 10 | 20 | 20 | 15 | 15 |
| Hc [Shore D] | 45 | 57 | 52 | 50 | 47 |
| Tc [mm] | 1.05 | 1.05 | 1.05 | 1.05 | 1.05 |
| Mc [g/10 min] | 10.0 | 10.0 | 11.3 | 10.4 | 10.4 |
| Fc [MPa] | 47 | 81 | 71 | 67 | 54 |
| Mc * Tc | 10.4 | 10.4 | 11.8 | 10.9 | 10.9 |
| C2 [mm] | 3.4 | 3.4 | 3.4 | 3.4 | 3.4 |
| Scuff resistance | Good | Good | Good | Good | Good |
| Moldability | Good | Good | Good | Good | Good |
| Flight distance [Yards] | 155.0 | 156.2 | 155.7 | 155.4 | 155.1 |
| Flight distance evaluation | A | A | A | A | A |
| Evaluation of feel at impact | A | D | B | B | B |
| Overall evaluation | A | D | B | B | B |

TABLE 8
Evaluation results

| | | | | Comparative | Comparative |
|---|---|---|---|---|---|
| | Example 6 | Example 7 | Example 8 | Example 6 | Example 7 |
| Core | F | H | I | G | G |
| C1 [mm] | 4.5 | 4.8 | 4.9 | 4.7 | 4.7 |
| Hs − Ho [Shore C] | 36 | 36 | 36 | 36 | 36 |
| A1 [/mm] | 1.92 | 1.92 | 1.63 | 1.92 | 1.92 |
| A2 [/mm] | 1.64 | 1.64 | 1.64 | 1.64 | 1.64 |
| A5 [/mm] | 2.00 | 2.00 | 2.00 | 2.00 | 2.00 |
| A6 [/mm] | 5.12 | 5.12 | 5.12 | 5.12 | 5.12 |
| Mid layer | Comp. 1 | Comp. 2 | Comp. 3 | Comp. 1 | Comp. 1 |
| Hm [Shore D] | 69 | 67 | 64 | 69 | 69 |
| Tm [mm] | 1.00 | 1.00 | 1.00 | 1.00 | 1.00 |
| Mm [g/10 min] | 4.9 | 5.2 | 5.4 | 4.9 | 4.9 |
| Fm [MPa] | 343 | 320 | 302 | 343 | 343 |
| Cover | Comp. F | Comp. E | Comp. E | Comp. G | Comp. H |
| P(I) [% by mass] | 87 | 90 | 90 | 90 | 90 |
| P(Na) [% by mass] | 0 | 0 | 0 | 6 | 11 |
| P(Zn) [% by mass] | 87 | 90 | 90 | 85 | 80 |
| P(Zn/I) [% by mass] | 100 | 100 | 100 | 94 | 89 |
| P(n) [% by mass] | 10 | 10 | 10 | 10 | 10 |
| Hc [Shore D] | 42 | 45 | 45 | 45 | 45 |
| Tc [mm] | 1.05 | 1.05 | 1.05 | 1.05 | 1.05 |
| Mc [g/10 min] | 10.1 | 10.0 | 10.0 | 10.2 | 10.4 |
| Fc [MPa] | 40 | 49 | 49 | 50 | 51 |
| Mc * Tc | 10.6 | 10.4 | 10.4 | 10.7 | 10.9 |
| C2 [mm] | 3.4 | 3.4 | 3.4 | 3.4 | 3.4 |
| Scuff resistance | Good | Good | Good | Bad | Bad |
| Moldability | Good | Good | Good | Good | Good |
| Flight distance [Yards] | 154.6 | 154.8 | 154.5 | 155.0 | 155.0 |
| Flight distance evaluation | B | B | B | A | A |
| Evaluation of feel at impact | A | A | A | A | A |
| Overall evaluation | B | B | B | D | D |

TABLE 9
Evaluation results

| | Comparative | | Comparative | Comparative | |
|---|---|---|---|---|---|
| | Example 8 | Example 9 | Example 9 | Example 10 | Example 10 |
| Core | G | F | H | I | I |
| C1 [mm] | 4.7 | 4.5 | 4.8 | 4.9 | 4.9 |
| Hs − Ho [Shore C] | 36 | 36 | 36 | 36 | 36 |
| A1 [/mm] | 1.92 | 1.92 | 1.92 | 1.63 | 1.63 |
| A2 [/mm] | 1.64 | 1.64 | 1.64 | 1.64 | 1.64 |
| A5 [/mm] | 2.00 | 2.00 | 2.00 | 2.00 | 2.00 |
| A6 [/mm] | 5.12 | 5.12 | 5.12 | 5.12 | 5.12 |
| Mid layer | Comp. 1 | Comp. 1 | Comp. 1 | Comp. 1 | Comp. 1 |
| Hm [Shore D] | 69 | 69 | 69 | 69 | 69 |
| Tm [mm] | 1.00 | 0.85 | 1.10 | 1.20 | 1.00 |
| Mm [g/10 min] | 4.9 | 4.9 | 4.9 | 4.9 | 4.9 |
| Fm [MPa] | 343 | 343 | 343 | 343 | 343 |
| Cover | Comp. I | Comp. E | Comp. E | Comp. E | Comp. E |
| P(I) [% by mass] | 100 | 90 | 90 | 90 | 90 |
| P(Na) [% by mass] | 0 | 0 | 0 | 0 | 0 |
| P(Zn) [% by mass] | 100 | 90 | 90 | 90 | 90 |
| P(Zn/I) [% by mass] | 100 | 100 | 100 | 100 | 100 |
| P(n) [% by mass] | 0 | 10 | 10 | 10 | 10 |
| Hc [Shore D] | 45 | 45 | 45 | 45 | 45 |
| Tc [mm] | 1.05 | 1.20 | 0.95 | 0.85 | 1.05 |
| Mc [g/10 min] | 6.3 | 10.0 | 10.0 | 10.0 | 10.0 |
| Fc [MPa] | 51 | 47 | 47 | 47 | 47 |
| Mc * Tc | 6.6 | 11.9 | 9.5 | 8.5 | 10.4 |
| C2 [mm] | 3.4 | 3.4 | 3.4 | 3.4 | 3.5 |
| Scuff resistance | Good | Good | Good | Good | Good |
| Moldability | Bad | Good | Bad | Bad | Good |
| Flight distance [Yards] | 155.0 | 154.7 | 155.3 | 155.4 | 155.1 |
| Flight distance evaluation | A | B | A | A | A |
| Evaluation of feel at impact | A | A | A | A | A |
| Overall evaluation | D | B | D | D | A |

As shown in Tables 6 to 9, the golf ball of each Example has excellent various performances. From the evaluation results, advantages of the present disclosure are clear.

### [Disclosure Items]

Each of the following items is a disclosure of a preferred embodiment.

### [Item 1]

A golf ball including a core, a mid layer positioned outside the core, and a cover positioned outside the mid layer, wherein
in a graph on which distances (mm) of and Shore C hardnesses at a central point of the core, a point P1 whose distance from the central point is 2.5 mm, a point P2 whose distance from the central point is 5.0 mm, a point P4 whose distance from the central point is 10.0 mm, a point P5 whose distance from the central point is 12.5 mm, and a point P6 whose distance from the central point is 15.0 mm, are plotted,
a slope A1 of a straight line connecting the central point and the point P1 is 1.00 or more,
a slope A2 of a straight line connecting the point P1 and the point P2 is 1.00 or more,
a slope A5 of a straight line connecting the point P4 and the point P5 is 1.50 or more, and
a slope A6 of a straight line connecting the point P5 and the point P6 is 1.50 or more,
a difference (Hs-Ho) between a Shore C hardness Hs at a surface of the core and a Shore C hardness Ho at the central point is 30 or more,
a material of the mid layer is a resin composition containing an ionomer resin as a principal component,
a material of the cover is a resin composition containing an ionomer resin as a principal component,
a ratio P(I) of an amount of the ionomer resin to a total amount of a base resin in the resin composition of the cover is 60% by mass or more,
a ratio P(Na) of an amount of a sodium ion-neutralized ionomer resin to the total amount of the base resin in the resin composition of the cover is 5% by mass or less,
a product (Mc*Tc) of a melt flow rate Mc (g/10 min) and a thickness Tc (mm) of the cover is 10.0 or more, and
the cover has a bending stiffness Fc of 75 MPa or less.

### [Item 2]

The golf ball according to Item 1, wherein
the base resin of the resin composition of the cover includes a zinc ion-neutralized ionomer resin, and
a ratio P(Zn) of an amount of the zinc ion-neutralized ionomer resin to the total amount of the base resin is 60% by mass or more.

### [Item 3]

The golf ball according to Item 1, wherein
the base resin of the resin composition of the cover includes a zinc ion-neutralized ionomer resin, and
a ratio P(Zn/I) of an amount of the zinc ion-neutralized ionomer resin to a total amount of the ionomer resin in the resin composition is 90% by mass or more.

### [Item 4]

The golf ball according to Item 2 or 3, wherein the base resin of the resin composition of the cover includes a first zinc ion-neutralized ionomer resin and a second zinc ion-neutralized ionomer resin.

### [Item 5]

The golf ball according to any one of Items 1 to 4, wherein the base resin of the resin composition of the cover includes
(1) an unneutralized resin that is a binary copolymer of an olefin and an α,β-unsaturated carboxylic acid, or
(2) an unneutralized resin that is a ternary copolymer of an olefin, an α,β-unsaturated carboxylic acid, and an α,β-unsaturated carboxylic acid ester, and
a ratio P(n) of a total amount of the binary copolymer resin (1) and the ternary copolymer resin (2) to the total amount of the base resin is 10% by mass or more and 40% by mass or less.

### [Item 6]

The golf ball according to any one of Items 1 to 5, wherein the melt flow rate Mc is 8.0 g/10 min.

### [Item 7]

The golf ball according to any one of Items 1 to 6, wherein the cover has a Shore D hardness of 40 or more and 50 or less.

### [Item 8]

The golf ball according to any one of Items 1 to 7, wherein the mid layer has a bending stiffness Fm of 300 MPa or more.

### [Item 9]

The golf ball according to any one of Items 1 to 8, wherein the core has an amount of compressive deformation C1 of 4.3 mm or more as measured under conditions of an initial load of 98 N and a final load of 1274 N, and the golf ball has an amount of compressive deformation C2 of 3.3 mm or more as measured under the same conditions.

The above-described golf ball is suitable for, for example, playing golf on golf courses and practicing at driving ranges.

What is claimed is:

1. A golf ball comprising a core, a mid layer positioned outside the core, and a cover positioned outside the mid layer, wherein
in a graph on which distances (mm) of and Shore C hardnesses at a central point of the core, a point P1 whose distance from the central point is 2.5 mm, a point P2 whose distance from the central point is 5.0 mm, a point P4 whose distance from the central point is 10.0 mm, a point P5 whose distance from the central point is 12.5 mm, and a point P6 whose distance from the central point is 15.0 mm, are plotted,
a slope A1 of a straight line connecting the central point and the point P1 is 1.00 or more,
a slope A2 of a straight line connecting the point P1 and the point P2 is 1.00 or more,
a slope A5 of a straight line connecting the point P4 and the point P5 is 1.50 or more, and
a slope A6 of a straight line connecting the point P5 and the point P6 is 1.50 or more,
a difference (Hs-Ho) between a Shore C hardness Hs at a surface of the core and a Shore C hardness Ho at the central point is 30 or more,
a material of the mid layer is a resin composition containing an ionomer resin as a principal component,
a material of the cover is a resin composition containing an ionomer resin as a principal component,
a ratio P(I) of an amount of the ionomer resin to a total amount of a base resin in the resin composition of the cover is 60% by mass or more,
a ratio P(Na) of an amount of a sodium ion-neutralized ionomer resin to the total amount of the base resin in the resin composition of the cover is 5% by mass or less,
a product (Mc*Tc) of a melt flow rate Mc (g/10 min) and a thickness Tc (mm) of the cover is 10.0 or more, and
the cover has a bending stiffness Fc of 75 MPa or less.

2. The golf ball according to claim 1, wherein
the base resin of the resin composition of the cover includes a zinc ion-neutralized ionomer resin, and
a ratio P(Zn) of an amount of the zinc ion-neutralized ionomer resin to the total amount of the base resin is 60% by mass or more.

3. The golf ball according to claim 1, wherein
the base resin of the resin composition of the cover includes a zinc ion-neutralized ionomer resin, and
a ratio P(Zn/I) of an amount of the zinc ion-neutralized ionomer resin to a total amount of the ionomer resin in the resin composition is 90% by mass or more.

4. The golf ball according to claim 2, wherein the base resin of the resin composition of the cover includes a first zinc ion-neutralized ionomer resin and a second zinc ion-neutralized ionomer resin.

5. The golf ball according to claim 1, wherein
the base resin of the resin composition of the cover includes
(1) an unneutralized resin that is a binary copolymer of an olefin and an α,β-unsaturated carboxylic acid, or
(2) an unneutralized resin that is a ternary copolymer of an olefin, an α,β-unsaturated carboxylic acid, and an α,β-unsaturated carboxylic acid ester, and
a ratio P(n) of a total amount of the binary copolymer resin (1) and the ternary copolymer resin (2) to the total amount of the base resin is 10% by mass or more and 40% by mass or less.

6. The golf ball according to claim 1, wherein the melt flow rate Mc is 8.0 g/10 min.

7. The golf ball according to claim 1, wherein the cover has a Shore D hardness of 40 or more and 50 or less.

8. The golf ball according to claim 1, wherein the mid layer has a bending stiffness Fm of 300 MPa or more.

9. The golf ball according to claim 1, wherein the core has an amount of compressive deformation C1 of 4.3 mm or more as measured under conditions of an initial load of 98 N and a final load of 1274 N, and the golf ball has an amount of compressive deformation C2 of 3.3 mm or more as measured under the same conditions.

10. A golf ball comprising a spherical core, a mid layer positioned outside the core, and a cover positioned outside the mid layer, wherein
the core has a hardness distribution in which a Shore C hardness increases from a central point toward a surface of the core,
a difference (Hs-Ho) between a Shore C hardness Hs at the surface of the core and a Shore C hardness Ho at the central point is 30 or more,
a material of the mid layer comprises an ionomer resin as a principal component,
a material of the cover comprises an ionomer resin as a principal component of a base resin with a ratio P(I) of at least 60% by mass,
a ratio of sodium ion-neutralized ionomer resin in the base resin of the cover is 5% by mass or less,
a product (Mc*Tc) of a melt flow rate Mc (g/10 min) and a thickness Tc (mm) of the cover is 10.0 or more, and
the cover has a bending stiffness of 75 MPa or less.

11. The golf ball according to claim 10, wherein
the hardness distribution of the core satisfies specific slope requirements at predetermined radial distances from the central point.

12. The golf ball according to claim 11, wherein
the base resin of the cover comprises at least 60% by mass of zinc ion-neutralized ionomer resin.

13. The golf ball according to claim 12, wherein
the cover has a thickness of 0.50 mm to 2.00 mm.

14. The golf ball according to claim 13, wherein
the mid layer has a thickness of 0.5 mm to 2.0 mm and a Shore D hardness of 50 to 90.

15. The golf ball according to claim 14, wherein
the core comprises a crosslinked rubber composition containing polybutadiene as a principal component.

16. The golf ball according to claim 15, wherein
the cover comprises an unneutralized copolymer resin in an amount of 10% to 40% by mass of the total base resin.

17. The golf ball according to claim 16, wherein
the golf ball has a diameter of 40 mm to 45 mm and a mass of 40 g to 50 g.

18. The golf ball according to claim 17, wherein
the core has a diameter of 35.0 mm to 40.5 mm.

19. The golf ball according to claim 18, wherein
the mid layer has a melt flow rate of 3.0 g/10 min or more and a bending stiffness of 300 MPa or more.

20. A multilayer golf ball comprising:
a rubber core having a central region and an outer region, wherein the outer region exhibits a Shore C hardness that exceeds a Shore C hardness of the central region by at least 30 units;
an intermediate layer surrounding the core and formed from a thermoplastic composition comprising ionomer resin; and
an outer layer surrounding the intermediate layer and formed from a thermoplastic composition wherein:
ionomer resin constitutes at least 60% by mass of base polymer content,
sodium-neutralized ionomer resin content does not exceed 5% by mass of the base polymer content,
the composition exhibits a melt flow rate of at least 8.0 g/10 min, and
the outer layer exhibits a flexural modulus not exceeding 75 MPa.
